(19) United States
(12) Patent Application Publication
(10) Pub. No.: US 2014/0373364 A1
(43) Pub. Date: Dec. 25, 2014

(54) UTILITY KNIFE

(71) Applicant: Cheng Zhang Li, Sussex, WI (US)

(72) Inventor: Cheng Zhang Li, Sussex, WI (US)

(73) Assignee: MILWAUKEE ELECTRIC TOOL CORPORATION, Brookfield, WI (US)

(21) Appl. No.: 14/342,033

(22) PCT Filed: Aug. 31, 2012
(86) PCT No.: PCT/US2012/053392

§ 371 Date: Jun. 3, 2014

Related U.S. Application Data
(60) Provisional application No. 61/529,673, filed on Aug. 31, 2011.
(60) Provisional application No. 61/656,315, filed on Jun. 6, 2012.

(51) Int. Cl. B26B 5/00; B25G 1/08; B26B 1/02

(52) U.S. Cl. CPC B26B 5/00; B26B 1/02; B25G 1/08
USPC 30/152; 30/156

(57) ABSTRACT

A utility knife including a handle having a slot that extends through a bottom side of the handle and a first blade holder that is pivotal with respect to the handle between an extended position where a blade is exposed and configured to cut a work-piece and a folded position where the blade is within the slot of the handle. The knife further includes a spare blade holder including a recess configured to receive a spare blade, and the spare blade holder is pivotal with respect to the handle between an open position where the recess is exposed to allow the spare blade to be removed from the spare blade holder and a closed position where the recess is within the slot of the handle to inhibit removal of the spare blade from the spare blade holder.

### CROSS-REFERENCE TO RELATED APPLICATIONS

This application claims priority to U.S. Provisional Application No. 61/656,315, filed Jun. 6, 2012 and to U.S. Provisional Application No. 61/529,673, filed Aug. 31, 2011, the entire contents of which are all incorporated herein by reference.

### BACKGROUND

The present invention relates to utility knives.

Utility knives typically include a handle and a blade carrier that either slides or pivots with respect to the handle so that the blade can be moved within the handle when the blade is not in use. Utility knife blades are often removable from the blade carrier so that a user can remove and replace the blade when it is worn or dull. Some utility knifes include a storage compartment for storing spare blades so that the user can replace a worn or dull blade with a blade from the storage compartment.

### SUMMARY

In one embodiment, the invention provides a utility knife including a handle having a first longitudinal side, a second longitudinal side opposite the first longitudinal side, a top side, a bottom side, and a slot that extends through the bottom side and the slot is between the first and second longitudinal sides. The knife further includes a blade, a first blade holder, and the blade is removably coupled to the first blade holder. The first blade holder is pivotal with respect to the handle between an extended position where the blade is exposed and configured to cut a work-piece and a folded position where the blade is within the slot of the handle. The knife further includes a spare blade holder including a recess configured to receive a spare blade, and the spare blade holder is pivotal with respect to the handle between an open position where the recess is exposed to allow the spare blade to be removed from the spare blade holder and a closed position where the recess is within the slot of the handle to inhibit removal of the spare blade from the spare blade holder.

In another embodiment the invention provides a utility knife including a handle having a first longitudinal side, a second longitudinal side opposite the first longitudinal side, a top side, a bottom side, a slot that extends through the bottom side and the slot is between the first and second longitudinal sides, and a longitudinal plane that extends through the top side and the bottom side and midway between the first longitudinal side and the second longitudinal side generally parallel to the first and second longitudinal sides. The knife further includes a blade, a first blade holder, and the blade is removably coupled to the first blade holder. The first blade holder is pivotal with respect to the handle between an extended position where the blade is exposed and configured to cut a work-piece and a folded position where the blade is within the slot of the handle between the longitudinal plane and the first longitudinal side. The knife further includes a spare blade holder including a recess configured to receive a spare blade, and the spare blade holder is movable with respect to the handle between an open position where the recess is exposed to allow the spare blade to be removed from the spare blade holder and a closed position where the recess is within the handle between the longitudinal plane and the second longitudinal side to inhibit removal of the spare blade from the spare blade holder.

Other aspects of the invention will become apparent by consideration of the detailed description and accompanying drawings.

### BRIEF DESCRIPTION OF THE DRAWINGS

FIG. 1 is a first side view of a utility knife according to an embodiment of the invention with a first blade holder in an extended position and a spare blade holder in an open position.

FIG. 2 is a first side view of the utility knife of FIG. 1 with a portion of the handle removed.

FIG. 3 is a first side view of the utility knife of FIG. 1 with the first blade holder in a folded position and the spare blade holder in the closed position.

FIG. 4 is a second side view of the utility knife of FIG. 1 with the first blade holder in the folded position and the spare blade holder in the closed position.

FIG. 5 is a top view of the utility knife of FIG. 1 with the first blade holder in the folded position and the spare blade holder in the closed position.

FIG. 6 is a bottom view of the utility knife of FIG. 1 with the first blade holder in the folded position and the spare blade holder in the closed position.

FIG. 7 is a perspective view of the utility knife of FIG. 1 with a portion of the handle removed.

FIG. 8 is an alternative perspective view of the utility knife of FIG. 1 with a portion of the handle removed.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

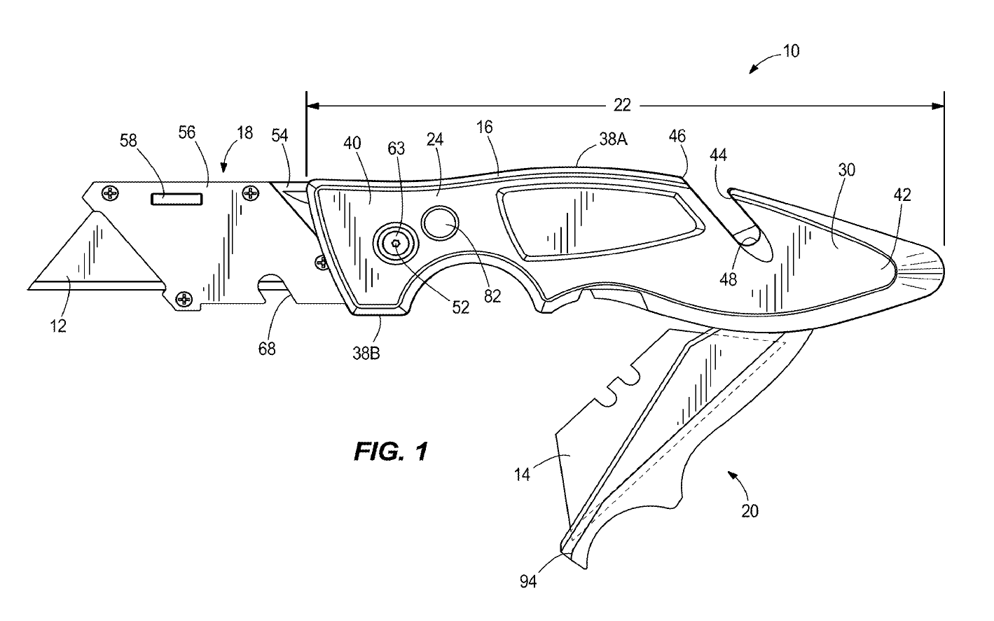

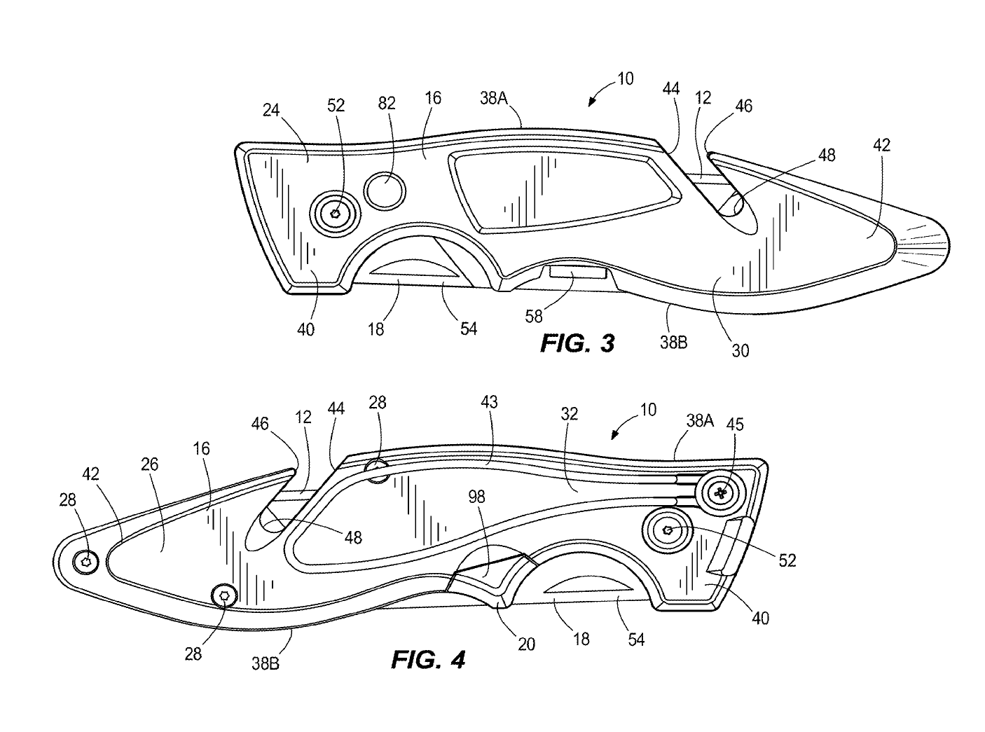

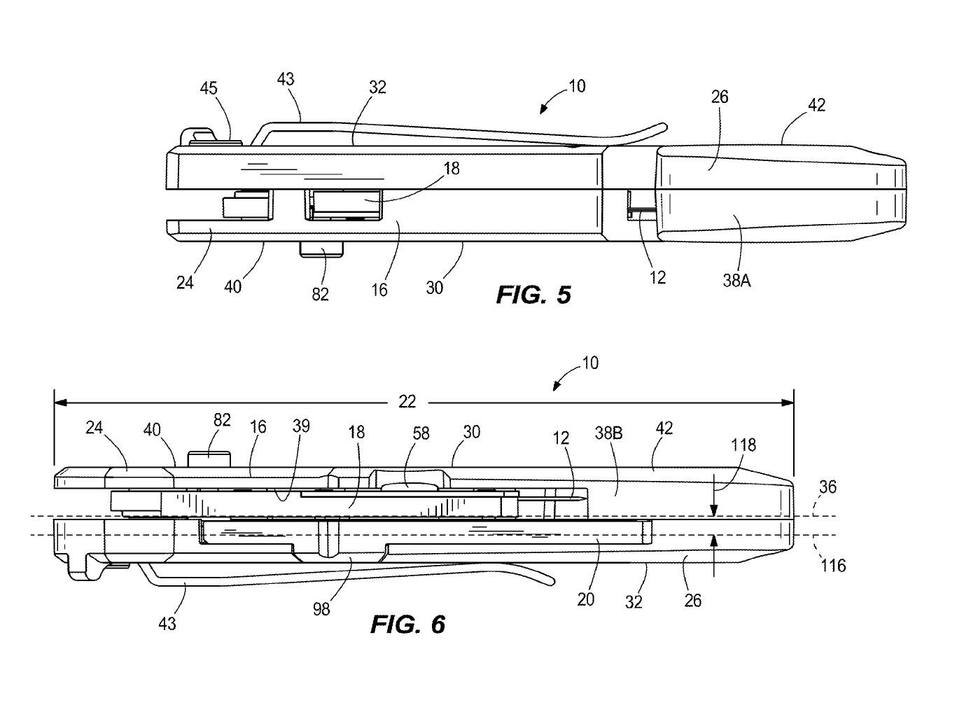

FIG. 1 illustrates a utility knife 10 that includes a removable cutting blade 12 and a spare blade 14 that can replace the blade 12 when the blade 12 becomes worn or dull. The utility knife 10 includes a handle or body 16, a first blade holder 18 that holds the blade 12 to cut a work piece and a second or spare blade holder 20 that holds the spare blade 14. As will be discussed in more detail below, the first blade holder 18 pivots with respect to the body 16 between an extended position (FIG. 1) and a folded position (FIG. 3) and the second blade holder pivots with respect to the body 16 between an open position (FIG. 1) and a closed position (FIG.

4).

Referring to FIGS. 1 and 4, the body 16 defines a length 22 and the body 16 includes a first body or handle portion 24 and a second body or handle portion 26 that are removably coupled via fasteners 28 to form the handle 16 of the utility knife 10. Referring to FIG. 6, the first body portion 24 forms a first planar longitudinal side 30 of the knife body 16 that generally faces a first direction and the second body portion 26 forms a second planar longitudinal side 32 of the knife body 16 that generally faces a second direction that is directly opposed to the first direction. The sides 30, 32 extend along substantially the entire length 22 of the body 16. A longitudinal plane 36 of the body 16 extends along the length 22 of the body 16 midway between the first side 30 and the second side 32 and generally parallel to the sides 30, 32. Although the sides 30, 32 are planar in the illustrated embodiment, in other embodiments, the sides can be curved or have other suitable shapes. The body 16 further includes a top side 38A, a bottom side 38B, and a slot 39 that opens through the bottom side 38B.

Referring to FIGS. 3 and 4, the body 16 includes a front portion 40 and a rear portion 42. A clip 43 is attached to the front portion 40 of the body 16 on the second side 32 of the body 16 by a fastener 45. The clip 43 allows the user to couple the knife 10 to their pocket, belt, tool belt, and the like. A generally U-shaped aperture 44 (FIG. 3) extends through the rear portion 42 of the body 16. The U-shaped aperture 44 includes an open end 46 and a closed end 48. The aperture 44 exposes a portion of the blade 12 when the first blade holder 18 is in the folded position, which allows the user to use the blade 12 to cut a work piece, such as rope, wire, wire insulation, and the like with the blade 12. As best seen in FIGS. 3 and 4, the spare blade 14 (FIG. 1) is not located in the U-shaped aperture 44 when the spare blade holder 20 is in the closed position. This inhibits the spare blade 14 from interfering with the work piece that is being cut by the blade 12 through the aperture 44.

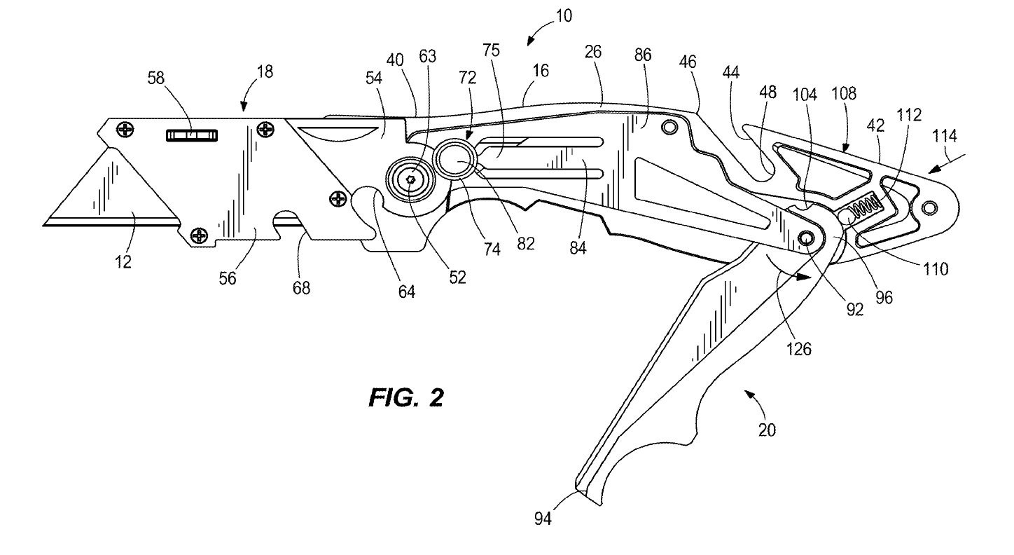

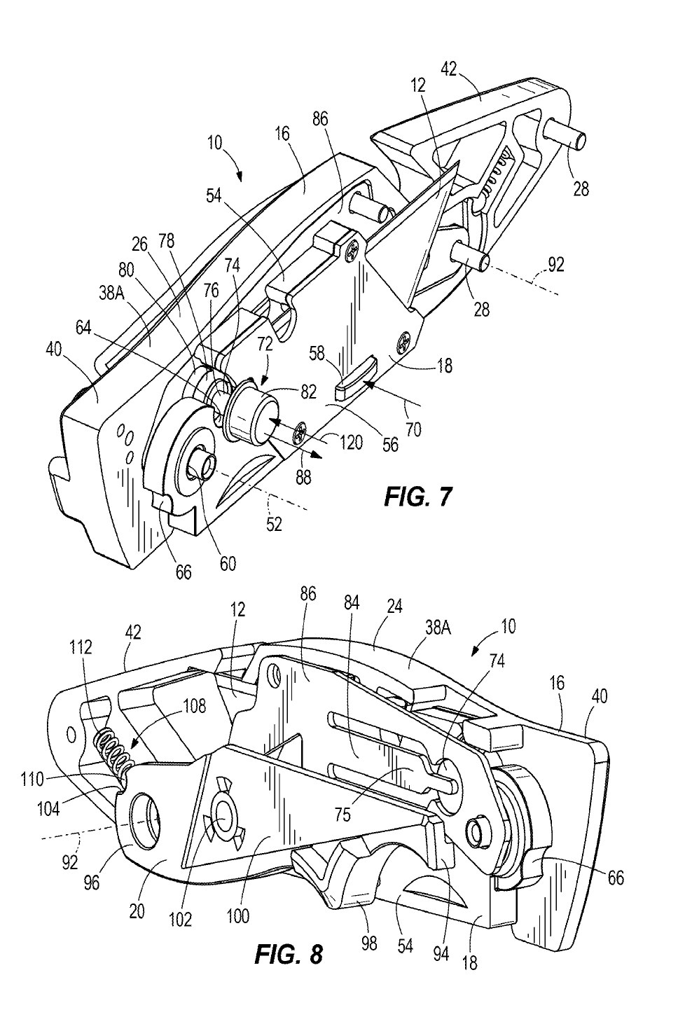

Referring to FIGS. 2 and 7, the first blade holder 18 is pivotally coupled to the front portion 40 of the body 16 such that the first blade holder 18 pivots about axis 52 between the extended position (FIG. 2) and the folded position (FIG. 7). The first blade holder 18 includes a base 54, a cover 56, and an actuator 58. The base 54 includes an aperture 60. A bushing or pin 62 extends through the aperture 60. The bushing 62 is internally threaded and a fasteners 63 (FIG. 2) extend into each end of the bushing 62 to pivotally couple the base 54 to the body 16 and to couple the body portions 24, 26. The base 54 further includes a first locking aperture 64 and a second locking aperture 66 that are circumferentially located around the aperture 60. Together the base 54 and the cover 56 define a generally U-shaped aperture 68 that exposes a portion of the blade 12 when the blade holder 18 is in the extended position so that the blade 12 and aperture 68 can be used to cut a work piece, including, rope, wire, wire insulation, etc.

With continued reference to FIGS. 1 and 7, the first blade holder 18 further includes the actuator 58. The actuator 58 can be manually pressed by the user, generally in the direction of arrow 70 of FIG. 7, to remove the blade 12 from the first blade holder 18 when the blade holder 18 is in the extended position (FIG. 1).

Referring to FIGS. 7 and 8, the knife 10 further includes a locking mechanism 72. The locking mechanism 72 includes a locking member 74 and a biasing member 75. The locking member 74 includes a shaft 76 that includes a first portion 78 having a diameter and a second portion 80 having a diameter that is larger than the diameter of the first portion 78. The illustrated second portion 80 is frusto-conical. The locking member 74 further includes a button 82 located at an end of the shaft 76. As best seen in FIG. 8, the biasing member 75 includes a cantilevered metal strip 84 and a base member or liner 86 captured between the body portions 24, 26. The cantilevered metal strip 84 biases the locking member in the direction of arrow 88 of FIG. 7.

Referring to FIGS. 2 and 8, the second or spare blade holder 20 is pivotally coupled to the rear portion 42 of the body 16 such that the spare blade holder 20 pivots with respect to the body 16 about an axis 92, which is parallel to the axis 52. The blade holder 20 includes a first end portion 94 and a second end portion 96. The first end portion 94 includes a grip 98 that allows the user to grip or grasp the blade holder 20 and pivot the blade holder 20 about the axis 92. The spare blade holder 20 further includes a recess 100 and a magnet 102 located within the recess 100 to retain the spare blades 14 within the recess 100 (only one blade 14 illustrated in the Figures although the blade holder 20 can retain more than one blade 14).

The spare blade holder 20 further includes a locking aperture 104 located within the second end portion 96 of the blade holder 20. A retaining mechanism 108 is located within the body 16 of the knife 10 adjacent the second end portion 96 of the spare blade holder 20. In the illustrated embodiment, the retaining mechanism 108 includes a ball 110 and a biasing member 112, which is a coil spring in the illustrated embodiment. The coil spring 112 biases the ball 110 in the direction of arrow 114 of FIG. 2.

Referring to FIGS. 6 and 8, the spare blade holder 20 defines a longitudinal plane 116 that extends through the center of the recess 100 along the length of the recess 100 generally parallel to the longitudinal plane 36 of the body 16. The longitudinal plane 116 of the blade holder 20 is offset a distance 118 from the longitudinal plane 36 of the handle 16 in a direction measured normal to the plane 36. As best seen in FIGS. 6 and 8, such a configuration of the blade holder 20 allows the spare blade holder 20 to overlap the first blade holder 18 along the length 22 of the knife body 16 when the first blade holder 18 is folded and the spare blade holder 20 is closed. Therefore, the length 22 of the knife body 16 is minimized compared to a design where the blade holders are placed end to end and the blade holders do not overlap. Also, the spare blades 14 are located on one side of the liner 86 while the cutting blade 12 is located on the other side of the liner 86.

In operation, referring to FIG. 7, the user presses the button 82 in the direction of arrow 120 to move the large diameter portion 80 of the shaft 76 out from within the first locking aperture 64, which allows the user to pivot the first blade holder 18 about the axis 52 from the folded position (FIG. 7), through the slot 39, and to the extended position (FIG. 1). With the button 82 released, the spring 84 moves the large diameter portion 80 of the shaft 76 in the biasing direction of arrow 88 and into the second locking aperture 66 to retain the blade holder 18 in the extended position. The frusto-conical shape of the large diameter portion 80 allows the portion 80 of the shaft 74 to wedge into the aperture 66. In the extended position, the user can use the blade 12 to cut a work piece. When the blade 12 becomes dull or worn, the user presses the button 58 in the direction of arrow 70 of FIG. 7, which allows the user to remove the blade 12 from the first blade holder 18.

Referring to FIGS. 2 and 4, if the user is holding the illustrated knife 10 in their right hand, the user can use their index finger on their right hand to push on the grip 98 (FIG. 4) to pivot the second or spare blade holder 20 about the axis 92 in the direction of arrow 126 to move the spare blade holder 20 from the closed position (FIG. 4), through the slot 39, and to the open position (FIG. 1). Referring to FIG. 8, when the spare blade holder 20 is in the closed position, the ball 110 is received in the locking aperture 104 and the bias of the spring 112 in the direction of arrow 114 retains the ball 110 within the aperture 104 and to retain the blade holder 20 in the closed position. When the user rotates the blade holder 20 toward the open position (FIG. 2), the ball 110 automatically rolls out of the locking aperture 104 to allow the user to rotate the blade holder 20. Although not illustrated, the blade holder 20 may include a second locking aperture into which the ball 110 eventually rolls into to retain the blade holder 20 in the open position.

With the blade holder 20 in the open position, the user can remove a spare blade 14 from the blade holder 20 and insert the blade 14 into the first blade holder 18. Then, the user can move the spare blade holder back to the closed position by pivoting the blade holder 20 about the axis 92 in a direction opposite the arrow 126 and resume using the knife 10 to cut a work piece.

When the user is finished using the knife 10 to cut the work piece, the user can move the first blade holder 18 back to the folded or storage position (FIG. 3). Referring to FIGS. 2 and 7, to move the first blade holder 18 from the extended position to the folded position, the user presses the button 82 in the direction of arrow 120 to move the large diameter portion 80 of the shaft 76 out from within the second locking aperture 66, which allows the user to pivot the first blade holder 18 about the axis 52 from the extended position (FIG. 2) to the folded position (FIG. 7). After beginning to rotate the blade holder 18, the user can release the button 82. With the button 82 released, the spring 84 moves the large diameter portion 80 of the shaft 76 in the biasing direction of arrow 88 and into the first locking aperture 64 when the aperture 64 is rotated into alignment with the shaft 76. The frusto-conical shape of the large diameter portion 80 allows the portion 80 of the shaft 74 to wedge into the aperture 64. When the large diameter portion 80 of the shaft 76 is within the first locking aperture 64 (FIG. 7), the blade holder 18 is retained in the folded position. As best seen in FIG. 6, when blade holder 18 is in the folded position, the blade 12 is within the slot 39 between the longitudinal plane 36 of the handle 16 and the first planar side 30 of the handle 30, and when the spare blade holder 20 is in the closed position, the recess 100 and the spare blades 14 (FIGS. 1 and 8) are within the slot 39 of the handle 30 between the longitudinal plane 36 and the second planar side 32 of the handle 30. This offset and overlapping arrangement of the first blade holder 16 and the spare blade holder 20 provides a compact knife that is easy to use.

Although the invention has been described in detail with reference to certain preferred embodiments, variations and modifications exist with the scope and spirit of one or more independent aspects of the invention as described.

What is claimed is:

1. A utility knife comprising:
a handle that includes a first longitudinal side, a second longitudinal side opposite the first longitudinal side, a top side, a bottom side, and a slot that extends through the bottom side and the slot is between the first and second longitudinal sides;
a blade;
a first blade holder, the blade removably coupled to the first blade holder, the first blade holder pivotal with respect to the handle between an extended position where the blade is exposed and configured to cut a work-piece and a folded position where the blade is within the slot of the handle; and
a spare blade holder including a recess configured to receive a spare blade, the spare blade holder pivotal with respect to the handle between an open position where the recess is exposed to allow the spare blade to be removed from the spare blade holder and a closed position where the recess is within the slot of the handle to inhibit removal of the spare blade from the spare blade holder.

2. The utility knife of claim 1, wherein the spare blade holder pivots through the slot and past the bottom side of the handle to pivot from the closed position to the open position.

3. The utility knife of claim 1, wherein the handle further includes a first end portion and a second end portion opposite the first end portion, and wherein the first blade holder is pivotally coupled to the handle adjacent the first end portion and the spare blade holder is pivotally coupled to the handle adjacent the second end portion.

4. The utility knife of claim 3, further comprising a first pin that extends through the first end portion of the handle to pivotally couple the first blade holder to the handle and a second pin that extends through the second end portion of the handle to pivotally couple the spare blade holder to the handle.

5. The utility knife of claim 1, wherein the first blade holder pivots about a first axis with respect to the handle, wherein the spare blade holder pivots about a second axis with respect to the handle, and wherein the first axis and the second axis are parallel.

6. The utility knife of claim 5, wherein, when viewed from the first longitudinal side of the handle, the first blade holder rotates about the first axis in a clockwise direction to move from the folded position to the extended position, and wherein, when viewed from the first longitudinal side of the handle, the spare blade holder rotates about the second axis in a counterclockwise direction to move from the closed position to the open position.

7. The utility knife of claim 1, further comprising a retaining mechanism operable to retain the spare blade holder in the folded position against the force of gravity.

8. The utility knife of claim 7, wherein the retaining mechanism includes a ball and a biasing member that biases the ball into a recess of the spare blade holder to retain the spare blade holder in the closed position.

9. The utility knife of claim 8, wherein the ball automatically rolls out of the recess when the spare blade holder is rotated from the closed position toward the open position.

10. The utility knife of claim 1, further comprising a liner within the slot between the first longitudinal side and the second longitudinal side of the handle, wherein the first blade holder is located between the liner and the first longitudinal side of the handle when the first blade holder is in the folded position, and wherein the spare blade holder is located between the liner and the second longitudinal side of the handle when the spare blade holder is in the closed position.

11. The utility knife of claim 1, wherein the handle defines a longitudinal plane that extends through the top side and the bottom side and midway between the first longitudinal side and the second longitudinal side generally parallel to the first and second longitudinal sides, wherein the blade is located between the longitudinal plane and the first longitudinal side when the first blade holder is in the folded position, and wherein the recess of the spare blade holder is located between the longitudinal plane and the second longitudinal side when the spare blade holder is in the closed position.

12. The utility knife of claim 1, further comprising a magnet located within the recess of the spare blade holder, the magnet configured to couple the spare blade to the spare blade holder.

13. The utility knife of claim 1, further comprising a generally U-shaped aperture in the handle having an opening that extends through the top side to expose a portion of the blade when the first blade holder is in the folded position.

14. A utility knife comprising:
a handle that includes a first longitudinal side, a second longitudinal side opposite the first longitudinal side, a top side, a bottom side, a slot that extends through the bottom side and the slot is between the first and second longitudinal sides, and a longitudinal plane that extends through the top side and the bottom side and midway between the first longitudinal side and the second longitudinal side generally parallel to the first and second longitudinal sides;
a blade;
a first blade holder, the blade removably coupled to the first blade holder, the first blade holder pivotal with respect to the handle between an extended position where the blade is exposed and configured to cut a work-piece and a folded position where the blade is within the slot of the handle between the longitudinal plane and the first longitudinal side; and
a spare blade holder including a recess configured to receive a spare blade, the spare blade holder movable with respect to the handle between an open position where the recess is exposed to allow the spare blade to be removed from the spare blade holder and a closed position where the recess is within the handle between the longitudinal plane and the second longitudinal side to inhibit removal of the spare blade from the spare blade holder.

15. The utility knife of claim 14, wherein the spare blade holder pivots through the slot and past the bottom side of the handle to pivot from the closed position to the open position.

16. The utility knife of claim 14, wherein the handle further includes a first end portion and a second end portion opposite the first end portion, and wherein the first blade holder is pivotally coupled to the handle adjacent the first end portion and the spare blade holder is pivotally coupled to the handle adjacent the second end portion.

17. The utility knife of claim 16, further comprising a first pin that extends through the first end portion of the handle to pivotally couple the first blade holder to the handle and a second pin that extends through the second end portion of the handle to pivotally couple the spare blade holder to the handle.

18. The utility knife of claim 14, wherein the first blade holder pivots about a first axis with respect to the handle, wherein the spare blade holder pivots about a second axis with respect to the handle, and wherein the first axis and the second axis are parallel.

19. The utility knife of claim 18, wherein, when viewed from the first longitudinal side of the handle, the first blade holder rotates about the first axis in a clockwise direction to move from the folded position to the extended position, and wherein, when viewed from the first longitudinal side of the handle, the spare blade holder rotates about the second axis in a counterclockwise direction to move from the closed position to the open position.

20. The utility knife of claim 14, further comprising a liner within the slot between the first longitudinal side and the second longitudinal side of the handle, wherein the first blade holder is located between the liner and the first longitudinal side when the first blade holder is in the folded position, and wherein the spare blade holder is located between the liner and the second longitudinal side when the spare blade holder is in the closed position.
